(19) United States
(12) Patent Application Publication
(10) Pub. No.: US 2026/0093243 A1
(43) Pub. Date: Apr. 2, 2026

(54) METHOD AND SYSTEM FOR GENERATING OPTIMIZED WORKSHOP SCHEDULES

(71) Applicant: Honeywell International Inc., Charlotte, NC (US)

(72) Inventors: Quan Long, West Hartford, CT (US); Riad Mohamed, Charlotte, NC (US)

(21) Appl. No.: 18/898,748

(22) Filed: Sep. 27, 2024

(51) Int. Cl. G05B 19/418; G06Q 10/0631

(52) U.S. Cl. CPC G05B 19/41865; G05B 19/41875; G05B 19/41885; G06Q 10/06312

(57) ABSTRACT

A system and method for generating optimized workshop schedules is disclosed, involving a multi-step process that integrates data collection, optimization, and machine learning. The method begins by collecting production data and routing information from an Enterprise Resource Planning (ERP) system or an Enterprise Data Warehouse (EDW) system. An optimization model then generates an initial workshop production schedule based on the collected data. This schedule is subsequently fine-tuned to create an enriched schedule that incorporates alternative routing information and more realistic data constraints. A supervised Machine Learning (ML) model is trained using the enriched schedule to learn the embedded data constraints and objectives. Finally, the trained ML model is deployed to generate highly accurate workshop schedules, ensuring efficient and effective production processes. This method enhances scheduling accuracy and operational efficiency in manufacturing environments.

### TECHNICAL FIELD

The present disclosure relates to a workshop scheduling system and more particularly, the present disclosure relates to a method and a system for generating optimized workshop schedules.

### BACKGROUND

Effective workshop scheduling is critical for maximizing productivity and efficiency in manufacturing and production environments. Traditionally, workshop schedules have been manually created, relying heavily on the expertise and experience of planners. However, manual scheduling can be time-consuming, error-prone, and unable to adapt quickly to changing production demands and constraints. This necessitates the development of more sophisticated and automated methods for generating optimized workshop schedules.

Several methods have been employed in prior work to automate workshop scheduling, including rule-based systems, heuristic algorithms, and mathematical optimization models. Rule-based systems apply predefined rules to generate schedules, but they often lack flexibility and cannot handle complex scenarios effectively. Heuristic algorithms, such as genetic algorithms and simulated annealing, offer more adaptability but may not always find the optimal solution and can be computationally intensive. Mathematical optimization models, including linear programming and integer programming, provide a structured approach to finding optimal schedules by considering various constraints and objectives. However, these models often generate initial schedules that may not fully capture the complexities of real-world production environments. The main challenges in these approaches include handling dynamic changes in production demands, managing complex routing information, and incorporating realistic data constraints.

Thus, in view of the above mentioned challenges, there is a need for a method and system for generating optimized workshop schedules.

### SUMMARY

The present disclosure relates to a method and a system for generating optimized workshop schedules.

In an embodiment, a method for generating optimized workshop schedules is provided. The method includes collecting production data and routing information from an Enterprise Resource Planning (ERP) system or an Enterprise Data Warehouse (EDW) system. The method further includes generating, by an optimization model, a workshop production schedule based on the collected production data and routing information, and fine-tuning the workshop production schedule to create an enriched schedule including at least alternative routing information, wherein the fine-tuning of the workshop production schedule includes at least one of: balancing workloads among one or more resources in a workshop, and adjusting the workshop production schedule based on real-time information in the workshop. The method further includes training a supervised Machine Learning (ML) model to learn data constraints and one or more operational targets for generating an optimized workshop schedule based on the created enriched schedule, and deploying the trained ML model to generate a final schedule for use in the workshop based on the learned data constraints and the learned operational targets for generating the optimized workshop schedule.

In some embodiments, the production data collected from the ERP or EDW systems includes at least one of production orders, routing information, labor capacities, material availabilities, and work-in-progress requirements.

In some embodiments, the optimization model is configured to minimize production costs, maximize production efficiency, and adhere to production limitations, including deadlines, and resource availability in the workshop.

In some embodiments, the optimization model further configured to adhere to labor and/or machine capacities, and adhere to routing sequences, setup time, or alternative work centers production limitations in the workshop.

In some embodiments, balancing the workloads among one or more resources in the workshop includes reallocating the one or more resources by shifting work from one or more overloaded machines to one or more under loaded machines in the workshop.

In some embodiments, adjusting the workshop production schedule comprises adjusting start times of production orders if materials and/or labor are not available as initially scheduled.

In some embodiments, wherein the enriched schedule further comprises one or more of: addition of realistic data constraints based on up-to-date production data including machine capacities, maintenance schedules, workforce availability, shift patterns, and material handling limitations; start and end times for tasks; precise machine loading levels; and specific resource allocations.

In some embodiments, the supervised ML model being trained using a dataset that includes at least one of material numbers, order quantities, work centers, and start and end times of production tasks.

In some embodiments, the trained ML model is further configured to identify overloaded machines, and generate corrective actions to redistribute tasks to under loaded machines, balancing the workload across the workshop.

In some embodiments, the training of ML model comprises capturing of the workshop production schedule including the basic limitations and initial information.

In some embodiments, the method further comprising capturing alternative routings of manufacturing processes and facilitating the generation of new schedules via a cloud-based user interface.

In yet another embodiment, a system for generating optimized workshop schedules is disclosed. The system comprises an acquiring module, an optimization module, a fine-tuning module, and a Machine Learning (ML) module. The acquiring module is configured to collect production data and routing information from an Enterprise Resource Planning (ERP) system or an Enterprise Data Warehouse (EDW) system. The optimization module is configured to operatively run an optimization model to generate a workshop production schedule based on the collected production data and routing information. The fine-tuning module is configured to tune the workshop production schedule to create an enriched schedule including at least alternative routing information, wherein the fine-tuning of the workshop production schedule includes at least one of: balancing workloads among one or more resources in a workshop; and adjusting the workshop production schedule based on real-time information in the workshop. The Machine Learning (ML) module is configured to operatively run a supervised ML model to learn data constraints and one or more operational targets for generating an optimized workshop schedule based on the created enriched schedule, where the ML module being further configured to generate a final schedule for use in the workshop based on the learned data constraints and the learned operational targets for generating the optimized workshop schedule.

The supervised ML model automatically learns complex and implicit scheduling constraints, reducing the need for planners to explicitly formulate these constraints. This process is data-efficient, as the initial schedule already incorporates substantial information from the ERP system, minimizing the need for additional training data. The system enhances production efficiency by optimizing material flow and production processes, identifying overloaded machines, and redistributing tasks to under loaded machines, thereby improving overall efficiency and reducing manual scheduling efforts. Additionally, a cloud-based user interface is provided to capture alternative routings and facilitate the generation of new schedules, ensuring accessibility and seamless integration within the production environment.

In some embodiments, the acquiring unit configured to collect the production data from the ERP or EDW systems includes at least one of production orders, routing information, labor capacities, material availabilities, and work-in-progress requirements.

In some embodiments, the optimization module operatively runs the optimization model configured to minimize production costs, maximize production efficiency, and adhere to production limitations, including deadlines and resource availability in the workshop.

In some embodiments, the optimization model is further configured to adhere to labor and/or machine capacities; and adhere to routing sequences, setup time, or alternative work centers production limitations in the workshop.

In some embodiments, balancing the workloads among one or more resources in the workshop includes reallocating the one or more resources by shifting work from one or more overloaded machines to one or more under loaded machines in the workshop, and wherein adjusting the workshop production schedule comprises adjusting start times of production orders if materials and/or labor are not available as initially scheduled.

In some embodiments, the Machine Learning (ML) module is configured to train the ML model using a dataset that includes at least one of material numbers, order quantities, work centers, and start and end times of production tasks.

In some embodiments, the trained ML model is further configured to identify overloaded machines; and generate corrective actions to redistribute tasks to under loaded machines, balancing the workload across the workshop.

In some embodiments, the trained ML model is further configured to capture the workshop production schedule including the basic limitations and initial information.

In some embodiments, the system further comprising a cloud-based user interface configured to capture alternative routings of manufacturing processes and facilitating the generation of new schedules.

In yet another embodiment, a non-transitory computer-readable medium having stored thereon computer-readable instructions that, when executed by a processor, cause the processor to execute a method for generating optimized workshop schedules, comprising collecting production data and routing information from an Enterprise Resource Planning (ERP) system or an Enterprise Data Warehouse (EDW) system. The computer-readable instructions further cause the processor to generate, by an optimization model, a workshop production schedule based on the collected production data and routing information. The computer-readable instructions further cause the processor to fine-tune the workshop production schedule to create an enriched schedule including at least alternative routing information, wherein the fine-tuning of the workshop production schedule includes at least one of: balancing workloads among one or more resources in a workshop; and adjusting the workshop production schedule based on real-time information in the workshop. The computer-readable instructions further cause the processor to train a supervised Machine Learning (ML) model to learn data constraints and one or more operational targets for generating an optimized workshop schedule based on the created enriched schedule, and deploying the trained ML model to generate a final schedule for use in the workshop based on the learned data constraints and the learned operational targets for generating the optimized workshop schedule.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates a block diagram of a manufacturing workshop, depicting the sequential flow of materials and components through various stages of production according to an embodiment of the disclosure;

FIG. 2 illustrates a block diagram of a method for learning near-optimal workshop schedules within an enterprise environment according to an embodiment of the disclosure;

FIG. 3 illustrates a block diagram pertaining to a method for learning near-optimal workshop schedules within an enterprise environment according to an embodiment of the disclosure;

FIG. 4 illustrates a detailed block diagram of an optimization and data storage system focusing on the interaction between an Enterprise Data Warehouse (EDW), an optimizer, and various data storage components according to an embodiment of the disclosure;

FIG. 5 illustrates a flowchart related to generating optimized workshop schedules according to an embodiment of the disclosure;

FIG. 6 illustrates a system for generating optimized workshop schedules according to an embodiment of the disclosure; and

FIG. 7 illustrates a schematic diagram of another communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

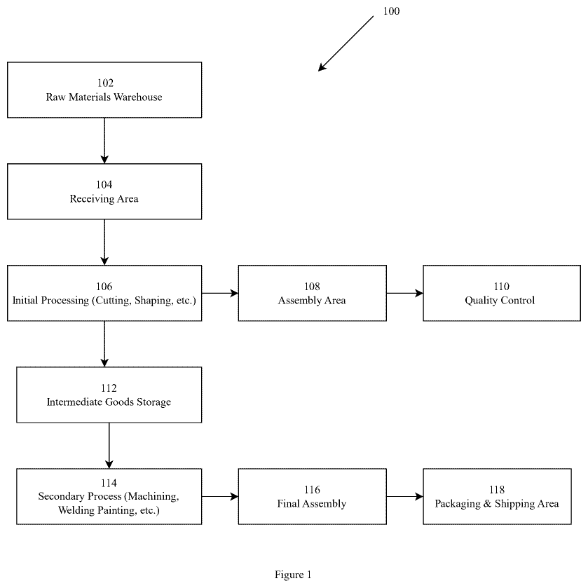

FIG. 1 illustrates a block diagram of a manufacturing workshop depicting a sequential flow of materials and components through various stages of production according to an embodiment of the disclosure. The diagram provides a comprehensive overview of the various stages involved in transforming raw materials into finished products. This diagram elucidates the workflow and interconnected processes essential for understanding the context of generating optimized workshop schedules, as disclosed in the present disclosure.

The process begins at a raw materials warehouse 102, where essential raw materials are stored. These materials are then moved to a receiving area 104, where the raw materials undergo initial inspection and logging into an Enterprise Resource Planning (ERP) or Enterprise Data Warehouse (EDW) system, ensuring accurate tracking and inventory management, forming the foundation for generating workshop schedules by providing crucial insights into the availability and status of the raw materials.

Following receipt of the raw materials at the receiving area 104, the raw materials are transferred to an initial processing area 106. The processing area 106 involves primary processing activities such as cutting, shaping, and preliminary treatments. Output from this stage is temporarily stored in an intermediate goods storage 112, awaiting further processing. Efficient scheduling at this stage ensures smooth transitions and prevents bottlenecks, highlighting the need for accurate scheduling solutions.

A secondary process area 114 handles advanced processing steps like machining, welding, and painting. The complexity of operations at this stage necessitates detailed routing information and realistic data constraints, which are captured and fine-tuned using an optimization model. Proper scheduling ensures that intermediate goods are processed in the most efficient sequence, considering available resources and time constraints.

Once secondary processing is complete, the components move to the assembly area, where sub-assemblies are put together. This stage is critical for integrating various components, and any delays can significantly impact the overall production schedule. In an embodiment, refined and enriched schedules generated by the optimization model, combined with the insights from a supervised Machine Learning (ML) model, ensure that the assembly process is streamlined and efficient.

After initial assembly, products move to a final assembly area 116, where all parts and components are integrated to form a final product. This stage must be planned to ensure that all necessary components are available at the right time, avoiding delays. The ML model's deployment at this stage ensures adaptability to any changes in production demands, and maintaining schedule accuracy.

A quality control area 110 is where finished products undergo rigorous inspection and testing to ensure they meet a required set of specifications. Efficient scheduling ensures that products move through quality control promptly, avoiding backlogs, and ensuring timely delivery.

Finally, the finished products are transferred to a packaging & shipping area 118. Products are packaged and prepared for shipment to customers. Accurate scheduling ensures that the packaging and shipping processes align with production schedules, guaranteeing on-time delivery.

In an embodiment, the output from the primary process can be directly moved to an assembly area 108, where sub-assemblies are put together and various components are integrated.

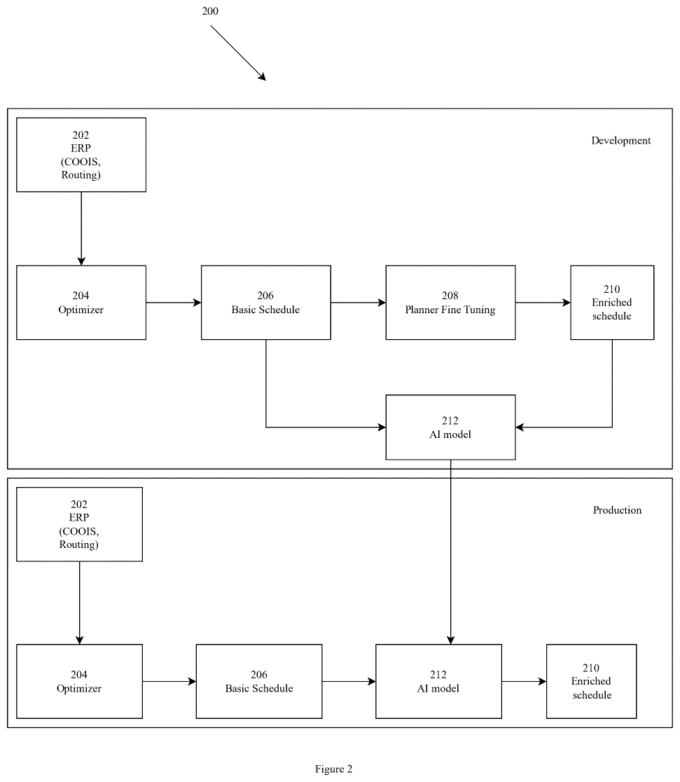

FIG. 2 illustrates a block diagram of a method 200 for learning near-optimal workshop schedules within an enterprise environment according to an embodiment of the disclosure. This method 200 involves several steps, from leveraging enterprise resource planning systems to utilizing machine learning models for refining schedules. The diagram is divided into two main sections: a development phase and a production phase, showing the flow of data and processes from an ERP system through various stages of optimization and refinement. The steps of method 200, as described in connection with the embodiments disclosed herein, may be realized through a variety of implementations, including directly in a hardware, via a firmware, through a software module executed by a computing system, or through any practical combination of these approaches.

In the development phase, the process begins with the collection and storage of data through an Enterprise Resource Planning (ERP) system 202. The ERP system, which includes modules like COOIS and routing, is crucial for maintaining comprehensive records of all production-related data, including inventory levels, production orders, work center capacities, and transactional data. In an embodiment, the data forms the foundational input for an optimization and scheduling processes. In another embodiment, the ERP system is configured to automatically update and synchronize data in real-time across various departments, ensuring that the information used for scheduling is accurate and up-to-date. Additionally, implementing robust data quality management protocols, such as regular audits and validation checks, ensures the integrity and accuracy of the data stored in the ERP or EDW.

An Optimizer 204 utilizes a mixed-integer programming code to generate a basic schedule. The optimizer 204 works with a set of constraints and an objective function to create an initial schedule. In an embodiment, the objective functions include minimizing the makespan of production orders on a shop floor or reducing the average cycle time of production orders. Constraints that the optimizer 204 must consider include labor/machine capacity, routing sequences, setup time, and the use of alternative work centers. In another embodiment, the basic schedule is stored using a cloud storage solution, providing scalability and accessibility for distributed teams. Advanced optimization algorithms can be implemented to handle large-scale scheduling problems efficiently. In an embodiment, the basic schedule 206 generates an initial basic schedule using an optimization model considering primary constraints such as production sequences, efficiency, deadlines, and resource availability.

A Basic Schedule 206 generated by the optimizer 204 might differ from reality due to potential discrepancies in data quality and inherent uncertainties. This schedule, based on master and transactional data in the ERP system 202, serves as the starting point for further refinement. Conducting a thorough analysis to identify and document discrepancies between the basic schedule and actual production capabilities or constraints is an essential step. Furthermore, implementing strategies to manage and mitigate uncertainties, such as predictive analytics to anticipate potential disruptions, enhances the validity of the basic schedule.

A planner 208 then reviews and fine-tunes the basic schedule to create an enriched schedule 210. This process involves reallocating resources, rescheduling production orders, and optimizing the workload distribution across multiple work centers. For instance, resource reallocation might involve shifting work from overloaded work centers to under loaded ones to balance the workload, or adjusting start times of production orders if materials are not available as initially scheduled. Providing planners 208 with interactive tools that allow for easy adjustments and real-time feedback on schedule changes can facilitate this fine-tuning process. The enriched schedule can be stored in a cloud storage solution to ensure collaboration and accessibility across different locations.

Based on the enriched data and the basic schedule, a supervised machine learning model is trained. The AI Model 212 learns the relationship between the initial basic schedule and the refined, enriched schedule. Utilizing algorithms such as XGBoost or transformers, known for their high accuracy and efficiency in handling large datasets, can significantly enhance the learning process. Periodic retraining is necessary to adapt to changes in the production environment. Setting up a monitoring system to detect model drift and automatically retrain the model when significant changes in data patterns are observed ensures the model remains accurate and relevant.

The machine learning model, once trained, predicts the adjustments needed to transform a basic schedule into an enriched schedule. It uses features such as material number, order quantity, work center number, and start date and time. Continuously refining the features used by the model to improve its predictive accuracy and deploying the model in a production environment where it can be used to automatically generate refined schedules is crucial for maintaining efficiency.

The enriched schedule 210 is generated based on the output of the machine learning model. This schedule 210 reflects the near-optimal allocation of resources and timing, ensuring efficient and effective production workflows. Implementing an automated system that generates and distributes the final schedule to relevant stakeholders ensures that production teams have access to the most current and accurate schedules. Continuously monitoring the performance of the final schedule to identify areas for further improvement and optimization helps maintain high productivity levels.

In the Production Phase, the process mirrors the development phase but operates in a real-time production environment. The ERP system 202 continuously collects and updates production data, which serves as the basis for scheduling. The Optimizer 204 generates the basic schedule 206 using the updated data, considering current constraints and objective functions. The AI Model 212 then applies the learned adjustments to refine the basic schedule, producing an enriched schedule 210 that is ready for implementation. This final schedule ensures smooth production flow, minimizing delays and maximizing resource utilization.

For example, in a discrete manufacturing environment, an ERP system continuously updates production order statuses and material availability. The optimizer generates the basic schedule that aims to minimize makespan. A planner reviews this schedule and reallocates tasks to balance workloads across work centers. The machine learning model, trained on historical data, predicts further adjustments needed. The final schedule is then generated and implemented, leading to improved efficiency and reduced cycle times.

In another scenario, an automotive manufacturing plant uses EDW to collect data from various sensors and IoT devices on the shop floor. The optimizer uses this data to create a basic schedule considering machine capacity and setup times. The planner fine-tunes the schedule, considering real-time data on material availability. The enriched schedule is used to train the machine learning model, which predicts optimal scheduling adjustments. The final schedule ensures smooth production flow, minimizing delays, and maximizing resource utilization.

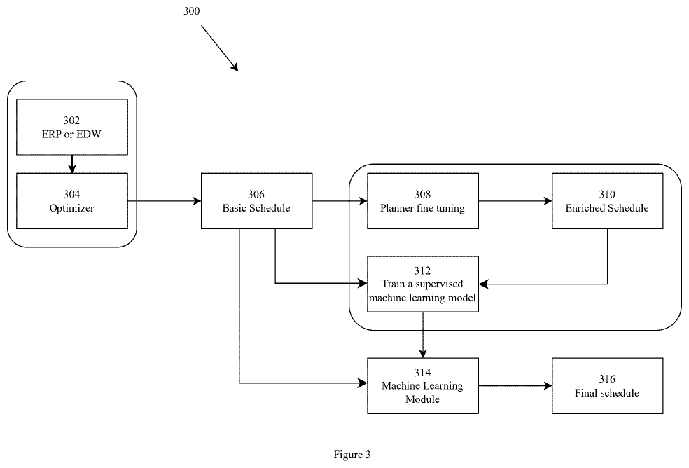

FIG. 3 illustrates a block diagram pertaining to method 300 for learning near-optimal workshop schedules within an enterprise environment according to an embodiment of the disclosure. This method 300 involves several steps, from leveraging enterprise resource planning systems to utilizing machine learning models for refining schedules. The steps of method 300, as described in connection with the embodiments disclosed herein, may be realized through a variety of implementations, including directly in a hardware, via a firmware, through a software module executed by a computing system, or through any practical combination of these approaches.

At the step 302, data is collected and stored through the Enterprise Resource Planning (ERP) system or an Enterprise Data Warehouse (EDW). In an embodiment, the system maintains comprehensive records of all production-related data, including, but not limited to, inventory levels, production orders, work center capacities, and transactional data. This data forms the foundational input for the optimization and scheduling processes that follow. In another embodiment, the ERP system automatically updates and synchronizes data in real-time across various departments, ensuring that the information used for scheduling is accurate and up-to-date. Additionally, implementing robust data quality management protocols, such as regular audits and validation checks, ensures the integrity and accuracy of the data stored in the ERP or EDW.

At the step 304, the optimizer utilises a mixed-integer programming code to generate a basic schedule. The optimizer works with a set of constraints and an objective function to create an initial schedule. In an exemplary embodiment, the objective functions include minimizing the makespan of production orders on a shop floor or reducing the average cycle time of production orders. Constraints that the optimizer must consider include labor/machine capacity, routing sequences, setup time, and the use of alternative work centers. In another embodiment, the basic schedule is stored using a cloud storage solution, providing scalability and accessibility for distributed teams. Advanced optimization algorithms can be implemented to handle large-scale scheduling problems efficiently.

In an embodiment, the basic schedule 306 generated by the optimizer might differ from reality due to potential discrepancies in data quality and inherent uncertainties. This schedule, based on the master and transactional data in the ERP system, serves as the starting point for further refinement. Conducting a thorough analysis to identify and document discrepancies between the basic schedule and actual production capabilities or constraints is an essential step. Furthermore, implementing strategies to manage and mitigate uncertainties, such as predictive analytics to anticipate potential disruptions, enhances the validity of the basic schedule. In an embodiment, the basic schedule 306 generates an initial basic schedule using an optimization model considering primary constraints such as production sequences, efficiency, deadlines, and resource availability.

A planner reviews and fine-tunes 308 the basic schedule to create an enriched schedule 310. This process involves reallocating resources, rescheduling production orders, and optimizing the workload distribution across multiple work centers. In an embodiment, resource reallocation might involve shifting work from overloaded work centers to underloaded ones to balance the workload, or adjusting the start times of production orders if materials are not available as initially scheduled. Providing planners with interactive tools that allow for easy adjustments and real-time feedback on schedule changes can facilitate this fine-tuning process. In an embodiment, the planner fine-tuning 308 uses human planners to adjust the basic schedule to better fit real-world workshop needs, which involves balancing workloads among alternative machines, and accounting for real-time material availability and labour capacities, correcting potential master data errors in the ERP/EDW systems.

In an embodiment, the enriched schedule 310 can be stored in a cloud storage solution to ensure collaboration and accessibility across different locations. Based on the enriched data and the basic schedule, the supervised machine learning model 312 is trained. This model learns the relationship between the initial basic schedule and the refined, enriched schedule. Utilizing algorithms such as XGBoost or transformers, known for their high accuracy and efficiency in handling large datasets, can significantly enhance the learning process. In an embodiment, periodic retraining is necessary to adapt to changes in the production environment. Setting up a monitoring system to detect model drift and automatically retrain the model when significant changes in data patterns are observed ensures the model remains accurate and relevant.

The machine learning mode 314, once trained, predicts the adjustments needed to transform a basic schedule and/or an enriched schedule into a final schedule. It uses features such as material number, order quantity, work center number, and start date and time. Continuously refining the features used by the model to improve its predictive accuracy and deploying the model in a production environment where it can be used to automatically generate refined schedules is crucial for maintaining efficiency. In an embodiment, the performance of the final schedule is continuously monitored to identify areas for further improvement and optimization help maintain high productivity levels.

Finally, the final schedule 316 is generated based on the output of the machine learning model. This schedule reflects the near-optimal allocation of resources and timing, ensuring efficient, and effective production workflows. Implementing an automated system that generates and distributes the final schedule to relevant stakeholders ensures that production teams have access to the most current and accurate schedules. Continuously monitoring the performance of the final schedule to identify areas for further improvement and optimization helps maintain high productivity levels.

For example, in a discrete manufacturing environment, the ERP system 302 continuously updates production order statuses and material availability. The optimizer 304 generates a basic schedule 306 that aims to minimize makespan. The planner reviews this schedule and reallocates tasks to balance workloads across work centers. The machine learning model, trained on historical data, predicts further adjustments needed. The final schedule is then generated and implemented, leading to improved efficiency and reduced cycle times.

In another embodiment, the automotive manufacturing plant uses EDW to collect data from various sensors and IoT devices on the shop floor. The optimizer uses this data to create a basic schedule considering machine capacity and setup times. The planner fine-tunes the schedule, considering real-time data on material availability. The enriched schedule is used to train the machine learning model, which predicts optimal scheduling adjustments. The final schedule ensures smooth production flow, minimizing delays and maximizing resource utilization.

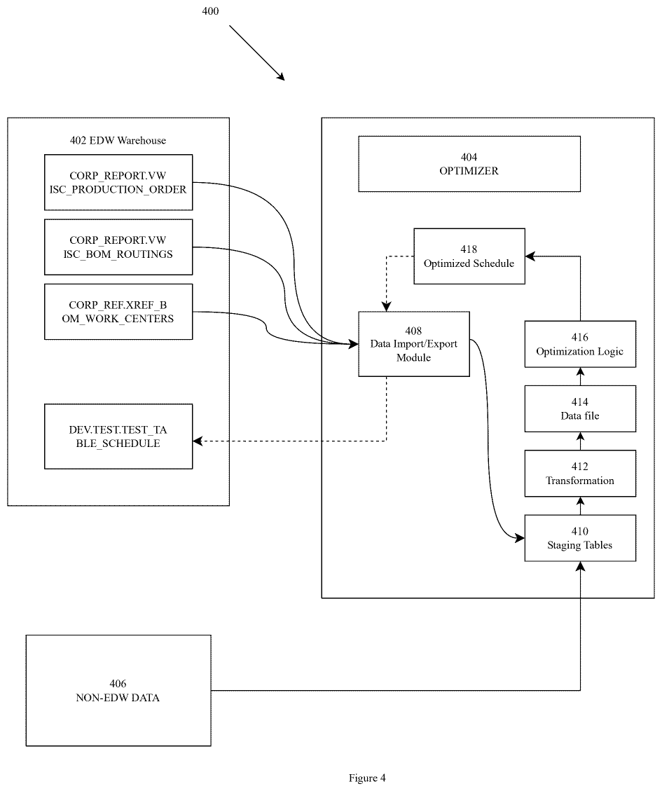

FIG. 4 illustrates a detailed block diagram of an optimization and data storage system 400, focusing on the interaction between an Enterprise Data Warehouse (EDW) 402, an optimizer 404, and various data storage components, according to an embodiment of the disclosure. The system 400 aims to generate optimized schedules for production processes by leveraging comprehensive data collection, transformation, and optimization techniques.

The EDW Warehouse 402 serves as the central repository for storing extensive production-related data. It contains multiple data views and tables essential for the optimization process. Key components within the EDW include:

1. CORP_REPORT.VW ISC_PRODUCTION_ORDER,
2. CORP_REPORT.VW ISC_BOM_ROUTINGS,
3. CORP_REF.XREF_BOM_WORK_CENTERS, and
4. DEV.TEST.TEST_TABLE_SCHEDULE.

CORP_REPORT.VW ISC_PRODUCTION_ORDER holds detailed information about production orders, including order quantities, due dates, earliest release dates, and priority levels. Accurate and up-to-date production order data is crucial for the optimizer 404 to create effective schedules. Further, CORP_REPORT.VW ISC_BOM_ROUTINGS contains Bill of Materials (BOM) and routing information, outlining the sequence of operations required for manufacturing each product. BOM and routing data ensure that the optimizer 404 considers all necessary production steps and material requirements.

CORP_REFXREF_BOM_WORK_CENTERS includes information related to work centers. In an embodiment, CORP_REFXREF_BOM_WORK_CENTERS includes mapped information related to Bill of Materials (BOM) components to specific work centers, providing information on where each production step will take place. Work center data helps the optimizer allocate resources efficiently and avoid bottlenecks. Furthermore, DEV.TEST.TEST_TABLE_SCHEDULE includes table which stores optimized schedule and/or test schedules used for validation and testing purposes. It allows for simulation and testing of various scheduling scenarios before implementation.

In addition to data stored in the EDW, in an embodiment, the system 400 also incorporates Non-EDW Data 406. This data includes external data sources such as market demand forecasts, supplier delivery schedules, and real-time production data from Internet of Thing (IoT) devices. Integrating Non-EDW Data ensures that the optimizer has access to comprehensive and up-to-date information, enhancing the accuracy and relevance of the optimized schedules.

The Optimizer 404 is the core component responsible for generating optimized schedules. The Optimizer 404 comprises several sub-modules, each performing specific functions to transform and optimize data including data import/export module 408, staging tables 410, transformation 412, data file 414, optimization logic 416, and optimized schedule 418.

The optimizer 404 facilitates the import of data from the EDW and Non-EDW sources into the optimizer. It ensures seamless data flow between the data repositories and optimization logic. In an embodiment, the data import/export module 408 supports real-time data synchronization to keep the optimizer 404 updated with the latest information.

Before data undergoes optimization, it is stored in the staging tables 410. These tables act as temporary storage, allowing for data transformation and cleaning processes to be applied. The staging tables ensure that only accurate and relevant data is used in the optimization process.

Transformation sub-module 412 transforms the raw data into a format suitable for optimization. It includes data cleaning, normalization, and enrichment processes. Transformation ensures that data inconsistencies are resolved and that the data is structured correctly for the optimizer 404.

The transformed data is stored in a data file 414, which acts as an intermediary storage before being processed by the optimization logic 416. The data file 414 ensures that the optimizer404 has access to all required data inputs in a structured and organized manner.

Optimization logic 416 is the heart of the optimizer 404, where algorithms and mixed-integer programming techniques are applied to generate optimized schedules. The optimization logic considers various constraints, such as machine capacity, labor availability, and production deadlines to create schedules that minimize makespan or cycle time. In an exemplary embodiment, advanced optimization techniques, such as genetic algorithms or simulated annealing, are employed to enhance the efficiency and accuracy of the scheduling process.

The output of the optimization process is the Optimized Schedule 418, which outlines the optimal sequence and allocation of production tasks. This schedule ensures efficient utilization of resources, minimizes production delays, and meets delivery deadlines. The optimized schedule is exported back to the EDW and other relevant systems for implementation.

In an exemplary embodiment, the EDW Warehouse 402 and Non-EDW Data 406 are integrated into a cloud-based platform, providing scalability, and accessibility for distributed manufacturing environments. This integration allows for real-time data updates and synchronization across multiple production sites.

Another embodiment involves the use of machine learning algorithms within the optimization logic to continuously improve the scheduling process. The optimizer 404 can learn from historical data and adapt to changing production conditions, enhancing its predictive accuracy and responsiveness.

Additionally, in an embodiment, the Data Import/Export Module 408 can be configured to support various data formats and protocols, ensuring compatibility with different data sources and systems. This flexibility allows for seamless integration with existing IT infrastructure and minimizes the need for extensive data migration efforts.

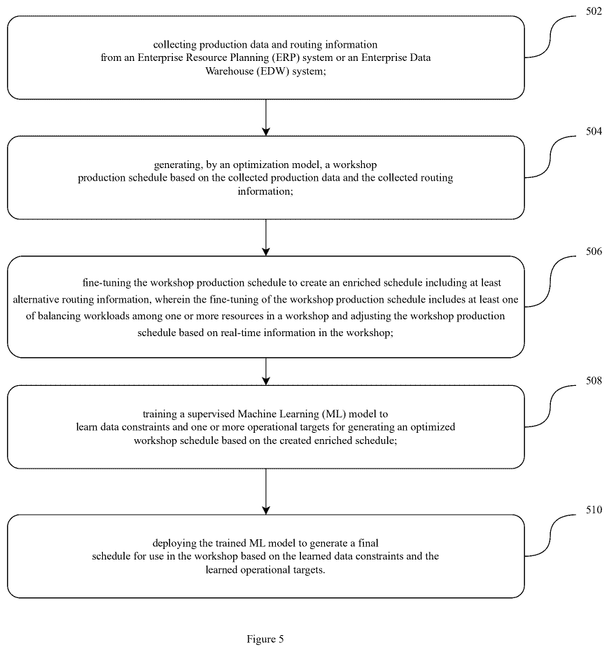

FIG. 5 illustrates a flowchart related to generating optimized workshop schedules according to an embodiment of the disclosure. The method 500 involves a systematic approach that leverages production data, optimization, and machine learning to produce efficient and realistic workshop schedules.

The process begins with step 502, which involves collecting production data and routing information from an Enterprise Resource Planning (ERP) system or an Enterprise Data Warehouse (EDW) system. The collected data includes but is not limited to, production orders, routing information, labor capacities, material availabilities, and work-in-progress requirements. In an embodiment, the ERP system provides real-time updates, while the EDW system offers historical data, ensuring both current and past performance are considered in schedule generation. This foundational data is crucial for generating a practical and effective schedule, as it provides a comprehensive view of the available resources and constraints.

In step 504, an optimization model uses this collected data to generate a workshop production schedule. This model is configured to minimize production costs, maximize production efficiency, and adhere to production limitations such as deadlines and resource availability. In another embodiment, the optimization model also considers labor and machine capacities, routing sequences, setup times, and the use of alternative work centers. For example, the model may determine the most efficient sequence of operations, considering the specific capabilities of each machine and the availability of skilled labor, to ensure balanced workloads and avoid bottlenecks.

Step 506 involves fine-tuning the initially generated schedule to create an enriched schedule that reflects alternative routing information and more realistic data constraints. This fine-tuning process includes balancing workloads among alternative machines and adjusting schedules based on real-time material availability and labor capacities. In an embodiment, the fine-tuning process is conducted by a planner who reallocates resources to address discrepancies between the optimized schedule and actual shop floor conditions. For instance, if a machine is unexpectedly out of service, the planner can adjust the schedule to utilize alternative equipment or shift workloads to less utilized machines, ensuring continuous production flow. In an embodiment, the fine-tuning of the workshop production schedule includes at least one of balancing workloads among one or more resources in a workshop; and adjusting the workshop production schedule based on real-time information in the workshop.

In step 508, a supervised Machine Learning (ML) model is trained to understand the data constraints and operational targets for generating an optimized workshop schedule based on the enriched schedule. The ML model learns from a dataset that includes material numbers, order quantities, work centers, and the start and end times of production tasks. In an embodiment, the ML model is trained using techniques such as gradient boosting (e.g., XGBoost) or transformers, which can capture complex patterns and relationships within the data. The training process captures the workshop production schedule's basic limitations and initial information, ensuring the model accurately reflects real-world constraints and objectives. The ML model continuously learns and adapts to new data, improving its predictive accuracy over time.

The trained ML model is then deployed in step 510 to generate a final schedule for use in the workshop based on the learned data constraints and the learned operational targets for generating the optimized workshop schedule. This ML model is configured to identify overloaded machines and generate corrective actions to redistribute tasks to underloaded machines, balancing the workload across the workshop. In an embodiment, the ML model incorporates feedback mechanisms to learn from any deviations between the predicted and actual outcomes, further enhancing its scheduling accuracy. For example, if a production delay occurs, the ML model analyzes the cause and adjusts future schedules to prevent similar issues.

Furthermore, the method includes capturing alternative routings of manufacturing processes and facilitating the generation of new schedules via a cloud-based user interface. This interface allows users to interact with the scheduling system remotely, providing flexibility and enhancing collaboration. In an embodiment, the cloud-based interface includes visualization tools that display the current production schedule, resource utilization, and potential bottlenecks, enabling planners to make informed decisions quickly.

To illustrate the versatility of the method, consider an exemplary embodiment where the optimization model integrates with a predictive maintenance system. In this scenario, the model not only schedules production tasks but also incorporates machine health data to predict and prevent equipment failures. By scheduling maintenance activities during low-demand periods, the method ensures minimal disruption to production and extends the lifespan of critical machinery.

This method for generating optimized workshop schedules integrates advanced data collection, optimization, and machine learning techniques to produce efficient and practical production schedules. By continuously improving through machine learning and incorporating real-time adjustments, the method enhances overall operational efficiency in manufacturing environments, ensuring timely delivery and optimal resource allocation.

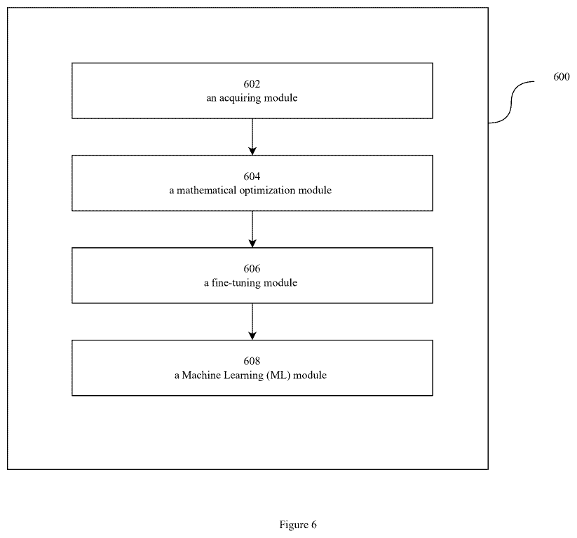

FIG. 6 illustrates a system 600 for generating optimized workshop schedules according to an embodiment of the disclosure. The system 600 encompasses several key components including an acquiring module 602, an optimization module 604, a fine-tuning module 606, and a machine learning module 608. Each module plays a crucial role in the overall process, ensuring the generation of efficient and practical workshop schedules.

The acquiring module 602 is responsible for collecting production data and routing information from an Enterprise Resource Planning (ERP) system or an Enterprise Data Warehouse (EDW) system. This module gathers essential data such as production orders, routing sequences, labor capacities, material availability, and work-in-progress requirements. In an embodiment, the acquiring module continuously updates the data in real-time from the ERP system, while the EDW system provides historical data for trend analysis and forecasting. This comprehensive data collection ensures that the subsequent steps are based on accurate and up-to-date information.

Next, the optimization module 604 generates a workshop production schedule based on the collected data. This model is designed to minimize production costs, maximize efficiency, and adhere to various production limitations such as deadlines and resource availability. In an embodiment, the optimization model also considers constraints like labor and machine capacities, routing sequences, setup times, and alternative work centers. For instance, the model might generate a schedule that minimizes the makespan of production orders or reduces the average cycle time on the shop floor, ensuring optimal use of resources and timely completion of tasks.

In an embodiment, the EDW Warehouse serves as the central repository for storing extensive production-related data. It contains multiple data views and tables essential for the optimization process. The central repository holds detailed information about production orders, including order quantities, due dates, and priority levels. Accurate and up-to-date production order data is crucial for the optimizer to create effective schedules. In another embodiment, the central repository contains a bill of materials and routing information, outlining the sequence of operations required for manufacturing each product. The bill of materials and routing data ensure that the optimizer considers all necessary production steps and material requirements.

In another embodiment, the central repository maps the bill of materials components to specific work centers, providing information on where each production step will take place. Work center data helps the optimizer allocate resources efficiently and avoid bottlenecks. Furthermore, in another embodiment, the central repository stores test schedules used for validation and testing purposes. It allows for simulation and testing of various scheduling scenarios before implementation.

In addition to data stored in the EDW, the system also incorporates Non-EDW Data. This data includes external data sources such as market demand forecasts, supplier delivery schedules, and real-time production data from IoT devices. Integrating Non-EDW Data ensures that the optimizer has access to comprehensive and up-to-date information, enhancing the accuracy and relevance of the optimized schedules.

The Optimizer is the core component responsible for generating optimized schedules. In an embodiment, the Optimizer comprises several sub-modules, each performing specific functions to transform and optimize data including data import/export module, staging tables, transformation, data file, optimization logic, and optimized schedule.

The optimizer facilitates the import of data from the EDW and Non-EDW sources into the optimizer. It ensures seamless data flow between the data repositories and optimization logic. In an embodiment, the data import/export module supports real-time data synchronization to keep the optimizer updated with the latest information.

Before data undergoes optimization, it is stored in the staging tables. These tables act as temporary storage, allowing for data transformation and cleaning processes to be applied. The staging tables ensure that only accurate and relevant data is used in the optimization process.

The transformation sub-module transforms the raw data into a format suitable for optimization. It includes data cleaning, normalization, and enrichment processes. Transformation ensures that data inconsistencies are resolved and that the data is structured correctly for the optimizer.

The transformed data is stored in a data file, which acts as an intermediary storage before being processed by the optimization logic. The data file ensures that the optimizer has access to all required data inputs in a structured and organized manner.

Optimization logic comprises algorithms and mixed-integer programming techniques which are applied to generate optimized schedules. The optimization logic considers various constraints, such as machine capacity, labor availability, and production deadlines to create schedules that minimize makespan or cycle time. In an exemplary embodiment, the advanced optimization techniques, such as genetic algorithms or simulated annealing, are employed to enhance the efficiency and accuracy of the scheduling process.

The output of the optimization process is the optimized schedule, which outlines the optimal sequence and allocation of production tasks. This schedule ensures efficient utilization of resources, minimizes production delays, and meets delivery deadlines. The optimized schedule is exported back to the EDW and other relevant systems for implementation.

In an exemplary embodiment, the EDW Warehouse and Non-EDW Data are integrated into a cloud-based platform, providing scalability, and accessibility for distributed manufacturing environments. This integration allows for real-time data updates and synchronization across multiple production sites.

Another embodiment involves the use of machine learning algorithms within the optimization logic to continuously improve the scheduling process. The optimizer can learn from historical data and adapt to changing production conditions, enhancing its predictive accuracy and responsiveness.

Additionally, in an embodiment, the data import/export module is configured to support various data formats and protocols, ensuring compatibility with different data sources and systems. This flexibility allows for seamless integration with existing IT infrastructure and minimizes the need for extensive data migration efforts.

The fine-tuning module 606 further refines the generated schedule to create an enriched schedule that reflects alternative routing information and more realistic data constraints. This step involves balancing workloads among machines, adjusting schedules based on real-time material availability, and reallocating resources to avoid bottlenecks. In an embodiment, the fine-tuning process includes a planner manually adjusting the schedule to address any discrepancies between the optimized schedule and actual shop floor conditions. For example, if a machine is unexpectedly down, the planner can use the fine-tuning module to reassign tasks to other available machines, ensuring continuous production flow. In an embodiment, the fine-tuning of the workshop production schedule includes at least one of balancing workloads among one or more resources in a workshop, and adjusting the workshop production schedule based on real-time information in the workshop.

The machine learning module 608 then uses a supervised Machine Learning (ML) model to learn the data constraints one or more operational targets for generating an optimized workshop schedule based on the enriched schedule. This ML model is trained on a dataset that includes material numbers, order quantities, work centers, and the start and end times of production tasks. The ML model captures complex and implicit scheduling constraints that may be difficult for planners to formulate explicitly. This data-efficient approach leverages the enriched schedule, minimizing the need for additional training data. The ML model continuously improves its predictive accuracy by learning from new data and feedback. In an embodiment, the ML module generates a final schedule for use in the workshop based on the learned data constraints and the learned operational targets for generating the optimized workshop schedule.

One of the significant advantages of the system 600 is its ability to enhance production efficiency. By optimizing material flow and production processes, the system identifies overloaded machines and redistributes tasks to underloaded machines. This balancing act improves overall efficiency and reduces the manual effort required for scheduling. In an embodiment, the system includes feedback mechanisms that allow the ML model to learn from any deviations between the predicted and actual outcomes, further refining the scheduling process.

Additionally, the system 600 features a cloud-based user interface that captures alternative routings and facilitates the generation of new schedules. This interface ensures accessibility and seamless integration within the production environment. In an embodiment, the cloud-based interface provides visualization tools that display the current production schedule, resource utilization, and potential bottlenecks, enabling planners to make informed decisions quickly. The interface also supports remote access, allowing users to interact with the scheduling system from various locations, enhancing flexibility and collaboration.

In an exemplary embodiment, the optimization model can integrate with a predictive maintenance system. In this scenario, the model not only schedules production tasks but also incorporates machine health data to predict and prevent equipment failures. By scheduling maintenance activities during low-demand periods, the system ensures minimal disruption to production and extends the lifespan of critical machinery.

The system 600 for generating optimized workshop schedules integrates advanced data collection, optimization, fine-tuning, and machine learning techniques to produce efficient and practical production schedules. By continuously improving through machine learning and incorporating real-time adjustments, the system enhances overall operational efficiency in manufacturing environments, ensuring timely delivery and optimal resource allocation.

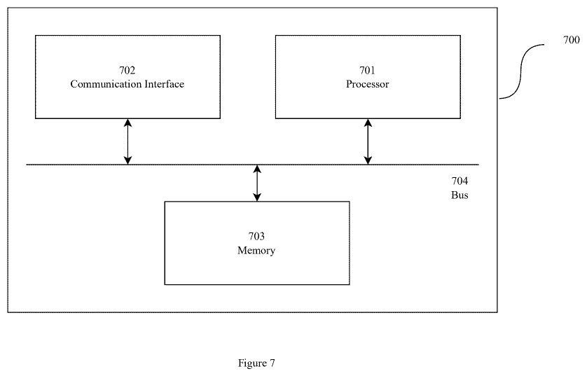

FIG. 7 illustrates a schematic diagram of another communication apparatus 700 according to an embodiment of the disclosure. The communication apparatus 700 includes a processor 701, a communication interface 702, and a memory 703. The processor 701, the communication interface 702, and the memory 703 may be connected to each other via a bus 704. The bus 704 may be a peripheral component interconnect (peripheral component interconnect, PCI) bus, an extended industry standard architecture (extended industry standard architecture, EISA) bus, or the like. The bus 704 may be classified into an address bus, a data bus, a control bus, and the like. For ease of representation, the bus is represented by using only one line in FIG. 7, but it does not indicate that there is only one bus or one type of bus. The processor 701 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 703 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for generating optimized workshop schedules, comprising:
collecting production data and routing information from an Enterprise Resource Planning (ERP) system or an Enterprise Data Warehouse (EDW) system;
generating, by an optimization model, a workshop production schedule based on the collected production data and the collected routing information;
fine-tuning the workshop production schedule to create an enriched schedule comprising at least alternative routing information, wherein the fine-tuning of the workshop production schedule includes at least one of:
balancing workloads among one or more resources in a workshop; and
adjusting the workshop production schedule based on real-time information in the workshop;
training a supervised Machine Learning (ML) model to learn data constraints and one or more operational targets for generating an optimized workshop schedule based on the created enriched schedule; and
deploying the trained ML model to generate a final schedule for use in the workshop based on the learned data constraints and the learned operational targets.

2. The method as claimed in claim 1, wherein the production data collected from the ERP or EDW systems includes at least one of:
production orders;
routing information;
labor capacities;
material availabilities; and
work-in-progress requirements.

3. The method as claimed in claim 2, wherein the optimization model configured to:
minimize production costs;
maximize production efficiency; and
adhere to production limitations, including deadlines and resource availability in the workshop.

4. The method as claimed in claim 1, wherein the optimization model further configured to:
adhere to labor and/or machine capacities; and
adhere to routing sequences, setup time, or alternative work centers production limitations in the workshop.

5. The method as claimed in claim 1, wherein balancing the workloads among the one or more resources in the workshop includes:
reallocating the one or more resources by shifting work from one or more overloaded machines to one or more under loaded machines in the workshop.

6. The method as claimed in claim 1, wherein adjusting the workshop production schedule comprises adjusting start times of production orders if materials and/or labor are not available as initially scheduled.

7. The method as claimed in claim 1, wherein the enriched schedule further comprising one or more of:
addition of realistic data constraints based on up-to-date production data including machine capabilities, maintenance schedules, workforce availability, shift patterns, and material handling limitations;
start and end times for tasks;
precise machine loading levels; and
specific resource allocations.

8. The method as claimed in claim 1, wherein the supervised ML model is trained using a dataset that includes at least one of:
material numbers;
order quantities;
work centers; and
start and end times of production tasks.

9. The method as claimed in claim 1, wherein the trained ML model configured to:
identify overloaded machines;
generate corrective actions to redistribute tasks to under loaded machines; and
balancing the workload across the workshop.

10. The method as claimed in claim 1, wherein the training of ML model comprises capturing of the workshop production schedule including the basic limitations and initial information.

11. The method as claimed in claim 1, further comprising:
capturing alternative routings of manufacturing processes and facilitating the generation of new schedules via a cloud-based user interface.

12. A system for generating optimized workshop schedules, comprising:
an acquiring module configured to collect production data and routing information from an Enterprise Resource Planning (ERP) system or an Enterprise Data Warehouse (EDW) system;
an optimization module configured to operatively run an optimization model to generate a workshop production schedule based on the collected production data and the collected routing information;
a fine-tuning module configured to tune the workshop production schedule to create an enriched schedule comprising at least alternative routing information, wherein the fine-tuning of the workshop production schedule includes at least one of:
balancing workloads among one or more resources in a workshop; and
adjusting the workshop production schedule based on real-time information in the workshop; and
a Machine Learning (ML) module configured to operatively run a supervised ML model to learn data constraints and one or more operational targets for generating an optimized workshop schedule based on the created enriched schedule, wherein the ML module being further configured to generate a final schedule for use in the workshop based on the learned data constraints and the learned operational targets.

13. The system as claimed in claim 12, wherein the acquiring unit configured to collect the production data from the ERP or EDW systems includes at least one of:
production orders;
routing information;
labor capacities;
material availabilities; and
work-in-progress requirements.

14. The system as claimed in claim 12, wherein the optimization module operatively runs the optimization model configured to:
minimize production costs;
maximize production efficiency; and
adhere to production limitations, including deadlines and resource availability in the workshop.

15. The system as claimed in claim 12, wherein the optimization model further configured to:
adhere to labor and/or machine capacities; and
adhere to routing sequences, setup time, or alternative work centers production limitations in the workshop.

16. The system as claimed in claim 12, wherein balancing the workloads among the one or more resources in the workshop includes reallocating the one or more resources by shifting work from one or more overloaded machines to one or more under loaded machines in the workshop, and wherein adjusting the workshop production schedule comprises adjusting start times of production orders if materials and/or labor are not available as initially scheduled.

17. The system as claimed in claim 12, wherein the Machine Learning (ML) module configured to train the ML model using a dataset that includes at least one of:
material numbers;
order quantities;
work centers; and
start and end times of production tasks.

18. The system as claimed in claim 12, wherein the trained ML model further configured to:
identify overloaded machines;
generate corrective actions to redistribute tasks to under loaded machines; and
balancing the workload across the workshop.

19. The system as claimed in claim 12, wherein the trained ML model further configured to capture the workshop production schedule including the basic limitations and initial information.

20. A non-transitory computer-readable medium having stored thereon computer-readable instructions that, when executed by a processor, cause the processor to execute a method for generating optimized workshop schedules, comprising:
collecting production data and routing information from an Enterprise Resource Planning (ERP) system or an Enterprise Data Warehouse (EDW) system;
generating, by an optimization model, a workshop production schedule based on the collected production data and the collected routing information;
fine-tuning the workshop production schedule to create an enriched schedule comprising at least alternative routing information, wherein the fine-tuning of the workshop production schedule includes at least one of:
balancing workloads among one or more resources in a workshop; and
adjusting the workshop production schedule based on real-time information in the workshop;
training a supervised Machine Learning (ML) model to learn data constraints and one or more operational targets for generating an optimized workshop schedule based on the created enriched schedule; and
deploying the trained ML model to generate a final schedule for use in the workshop based on the learned data constraints and the learned operational targets.
